(19) United States
(12) Patent Application Publication
(10) Pub. No.: US 2020/0243879 A1
(43) Pub. Date: Jul. 30, 2020

(54) FUEL CELL SYSTEM AND CONTROL METHOD OF FUEL CELL SYSTEM

(71) Applicant: TOYOTA JIDOSHA KABUSHIKI KAISHA, Toyota-shi (JP)

(72) Inventor: Hiromi TANAKA, Susono-shi (JP)

(73) Assignee: TOYOTA JIDOSHA KABUSHIKI KAISHA, Toyota-shi (JP)

(21) Appl. No.: 16/736,033

(22) Filed: Jan. 7, 2020

(30) Foreign Application Priority Data
Jan. 29, 2019 (JP) 2019-013610

(51) Int. Cl. H01M 8/04089; H01M 8/04082; H01M 8/04119

(52) U.S. Cl. CPC H01M 8/04097; H01M 2008/1095; H01M 8/04119; H01M 8/04201

(57) ABSTRACT

A fuel cell system includes a fuel cell, a first injector configured to inject fuel gas, a second injector configured to inject the fuel gas at an injection flow rate that is larger than that of the first injector, an ejector mechanism through which the fuel gas injected from each of the first injector and the second injector passes, a supply passage configured to supply the fuel gas passing through the ejector mechanism to the fuel cell, and a circulation passage configured to return the fuel gas discharged from the fuel cell to the ejector mechanism.

### INCORPORATION BY REFERENCE

The disclosure of Japanese Patent Application No. 2019-013610 filed on Jan. 29, 2019 including the specification, drawings and abstract is incorporated herein by reference in its entirety.

### BACKGROUND

### 1. Technical Field

The disclosure relates to a fuel cell system and a control method of the fuel cell system.

### 2. Description of Related Art

A fuel cell system including a first injector that injects fuel gas so that it passes through an ejector, and a second injector that injects the fuel gas at a larger flow rate than the first injector, without causing the gas to pass through the ejector, is known (see Japanese Unexamined Patent Application Publication No. 2014-059969 (JP 2014-059969 A)). The fuel gas injected from the first injector passes through the ejector, so that the fuel gas discharged from the fuel cell is recirculated into the fuel cell, along with the fuel gas injected from the first injector.

### SUMMARY

According to the technology of JP 2014-059969 A, the fuel gas injected from the second injector is supplied to the fuel cell, without passing through the ejector; therefore, the fuel gas discharged from the fuel cell cannot be recirculated into the fuel cell, solely with the fuel gas injected from the second injector. Thus, the fuel gas discharged from the fuel cell can be recirculated into the fuel cell, only when the fuel gas is injected from the first injector. Accordingly, fuel gas newly injected and fuel gas discharged from the fuel cell cannot be sufficiently mixed with each other, and fuel gas having a uniform concentration cannot be sufficiently diffused into the fuel cell, which may result in deterioration of the power generation performance.

The disclosure provides a fuel cell system that curbs deterioration of the power generation performance of a fuel cell, and a control method of the fuel cell system.

A first aspect of the disclosure is concerned with a fuel cell system including a fuel cell, a first injector configured to inject fuel gas, a second injector configured to inject the fuel gas at an injection flow rate that is larger than that of the first injector, an ejector mechanism through which the fuel gas injected from each of the first injector and the second injector passes, a supply passage configured to supply the fuel gas passing through the ejector mechanism to the fuel cell, and a circulation passage configured to return the fuel gas discharged from the fuel cell to the ejector mechanism.

According to the first aspect of the disclosure, no matter which of the first and second injectors injects the fuel gas, the injected fuel gas passes through the ejector mechanism. Thus, the fuel, gas newly injected and the fuel gas discharged from the fuel cell can be sufficiently mixed together and supplied to the fuel cell, and the power generation performance of the fuel cell is less likely or unlikely to deteriorate.

In the first aspect, the fuel cell system may further include a controller that controls the first injector and the second injector. The controller may control the second injector such that the second injector injects the fuel gas when a required output of the fuel cell is equal to or larger than a first threshold value. The controller may control the second injector such that the second injector inject the fuel gas when the required output is smaller than the first threshold value, and a remaining water amount in an anode channel of the fuel cell is equal to or larger than a second threshold value. The controller may control the first injector such that the first injector inject the fuel gas, when the required output is smaller than the first threshold value, and the remaining water amount is smaller than the second threshold value.

In the above aspect, the fuel cell system may further include a gas-liquid separator provided in the circulation passage and configured to separate water from the fuel gas, a discharge passage connected to the gas-liquid separator and configured to discharge the water separated from the fuel gas, and a discharge valve provided in the discharge passage. The controller may control the discharge valve to increase an opening and closing frequency of the discharge valve when the remaining water amount is equal to or larger than the second threshold value, as compared with the case where the remaining water amount is smaller than the second threshold value, under the same condition that the required output is smaller than the first threshold value.

In the above aspect, the controller may control the discharge valve to increase the opening and closing frequency of the discharge valve when a concentration of the fuel gas circulating through the fuel cell is lower than a third threshold value, as compared with the case where the concentration of the fuel gas is equal to or higher than the third threshold value, under the same conditions that the required output is smaller than the first threshold value, and the remaining water amount is smaller than the second threshold value.

In the above aspect, the controller may control an amount of the fuel gas injected from the first injector such that the fuel gas injected from the first injector is increased when a concentration of the fuel gas circulating through the fuel cell is lower than a fourth threshold value, as compared with the case where the concentration is equal to or higher than the fourth threshold value, under the same conditions that the required output is smaller than the first threshold value, and the remaining water amount is smaller than the second threshold value.

In the above aspect, the controller may control an amount of the fuel gas injected from the second injector such that the fuel gas injected from the second injector is reduced when the required output is smaller than the first threshold value, and the remaining water amount is equal to or larger than the second threshold value, as compared with the case where the required output is equal to or larger than the first threshold value.

In the above aspect, the ejector mechanism may include a single ejector through which the fuel gas injected from each of the first injector and the second injector passes.

In the above aspect, the ejector mechanism may include a first ejector and a second ejector located downstream of the first injector and the second injector, respectively. The circulation passage may include a first branch passage and a second branch passage that branch off from each other and are connected to the first ejector and the second ejector, respectively.

In the above aspect, the ejector mechanism may be connected to the first injector and the second injector, and the ejector mechanism may be configured to suck the fuel gas that circulates through the fuel cell, when the fuel gas is injected.

In the above aspect, the concentration of the fuel gas circulating through the fuel cell may be estimated from a concentration of the fuel gas of the supply passage or a concentration of the fuel gas of the circulation passage.

A second aspect of the disclosure is concerned with a control method of a fuel cell system, the fuel cell system including a fuel cell, a first injector configured to inject fuel gas, a second injector configured to inject the fuel gas at an injection flow rate that is larger than that of the first injector, an ejector mechanism through which the fuel gas injected from each of the first injector and the second injector passes, a supply passage configured to supply the fuel gas passing through the ejector mechanism to the fuel cell, and a circulation passage configured to return the fuel gas discharged from the fuel cell to the ejector mechanism. The control method includes detecting a required output of the fuel cell, estimating a remaining water amount in an anode channel of the fuel cell, and controlling injection of the fuel gas from the first injector and the second injector, based on the required output and the remaining water amount.

In the second aspect, the control method may further include controlling the second injector such that the second injector inject the fuel gas, when the required output of the fuel cell is equal to or larger than a first threshold value. The control method may further include controlling the second injector such that the second injector inject the fuel gas, when the required output is smaller than the first threshold value, and the remaining water amount in the anode channel of the fuel cell is equal to or larger than a second threshold value. The control method may further include controlling the first injector such that the first injector injects the fuel gas, when the required output is smaller than the first threshold value, and the remaining water amount is smaller than the second threshold value.

In the above aspect, the fuel cell system may further include a gas-liquid separator provided in the circulation passage and configured to separate water from the fuel gas, a discharge passage connected to the gas-liquid separator and configured to discharge the water separated from the fuel gas, and a discharge valve provided in the discharge passage. The control method may further include detecting a concentration of the fuel gas circulating through the fuel cell. The control method may further include controlling an opening and closing frequency of the discharge valve, based on the required output, the remaining water amount, or the concentration.

In the above aspect, the control method may further include controlling the opening and closing frequency of the discharge valve such that the opening and closing frequency of the discharge valve is increased when the remaining water amount is equal to or larger than the second threshold value, as compared with the case where the remaining water amount is smaller than the second threshold value, under the same condition that the required output is smaller than the first threshold value.

In the above aspect, the control method may further include controlling the opening and closing frequency of the discharge valve such that the opening and closing frequency of the discharge valve is increased when the concentration is lower than a third threshold value, as compared with the case where the concentration is equal to or higher than the third threshold value, under the same conditions that the required output is smaller than the first threshold value, and the remaining water amount is smaller than the second threshold value.

In the above aspect, the control method may further include detecting a concentration of the fuel gas circulating through the fuel cell, and controlling an amount of the fuel gas injected from the first injector or the second injector, based on the required output, the remaining water amount, or the concentration.

In the above aspect, the control method of may further include controlling the amount of the fuel gas injected from the first injector such that the amount of the fuel gas injected from the first injector is increased when the concentration in either of the supply passage and the circulation passage is lower than a fourth threshold value, as compared with the case where the concentration is equal to or higher than the fourth threshold value, under the same conditions that the required output is smaller than the first threshold value, and the remaining water amount is smaller than the second threshold value.

In the above aspect, the control method of may further include controlling the fuel gas injected from the second injector such that the fuel gas injected from the second injector is reduced when the required output is smaller than the first threshold value, and the remaining water amount is smaller than the second threshold value, as compared with the case where the required output is equal to or larger than the first threshold value.

In the above aspect, the concentration of the fuel gas circulating through the fuel cell may be estimated from a concentration of the fuel gas of the supply passage or a concentration of the fuel gas of the circulation passage.

According to each aspect of the disclosure, the fuel cell system that curbs deterioration of the power generation performance of the fuel cell, and the control method of the fuel cell system, can be provided.

### BRIEF DESCRIPTION OF THE DRAWINGS

Features, advantages, and technical and industrial significance of exemplary embodiments of the disclosure will be described below with reference to the accompanying drawings, in which like numerals denote like elements, and wherein:

FIG. 1 is a view showing the configuration of a fuel cell system;

FIG. 2 is a view showing the configuration of a multi-nozzle ejector;

FIG. 3 is a flowchart illustrating one example of switching control;

FIG. 4 is a timing chart illustrating one example of switching control;

FIG. 5 is a flowchart illustrating switching control of a modified embodiment; and

FIG. 6 is a view showing a part of a fuel cell system of a modified embodiment.

### DETAILED DESCRIPTION OF EMBODIMENTS

### Configuration of Fuel Cell System

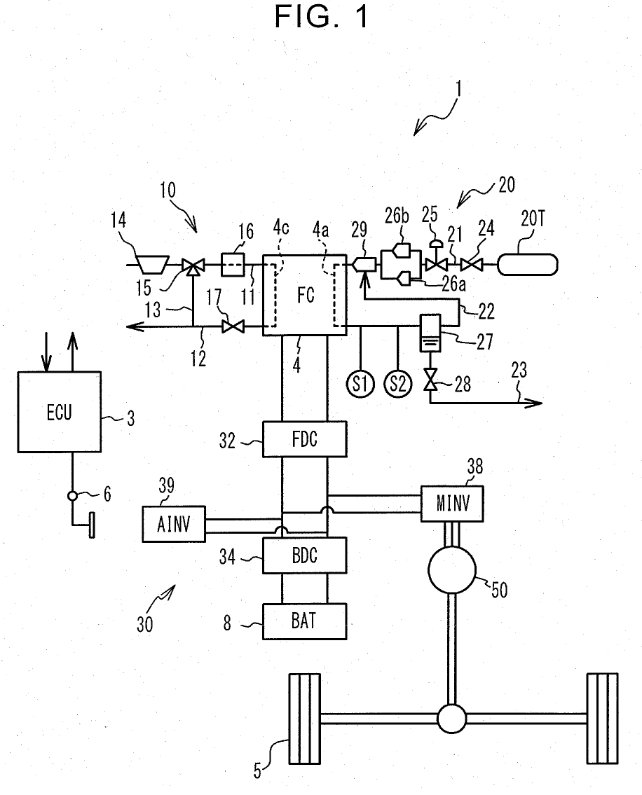

FIG. 1 shows the configuration of a fuel cell system 1. The fuel cell system 1 is installed on a vehicle, and includes an electronic control unit (ECU) 3, fuel cell (which will be called “FC”) 4, secondary battery (which will be called “BAT”) 8, oxidant gas supply system 10, fuel gas supply system 20, and power control system 30. The fuel cell system 1 includes a cooling system (not shown) that cools the FC 4 by circulating cooling water through the FC 4. Also, the vehicle includes a motor 50 for running the vehicle, wheels 5, and accelerator pedal position sensor 6.

The FC 4 has a plurality of solid polymer electrolyte type unit cells stacked together, and the unit cells generate electric power when they are supplied with oxidant gas and fuel gas. A cathode channel 4c in which the oxidant gas flows, and an anode channel 4a in which the fuel gas flows, are fat led in the FC 4. Each of the unit cells principally consists of a membrane-electrode assembly, and cathode-side separator and anode-side separator that sandwich the membrane-electrode assembly therebetween. The cathode channel 4c is mainly defined between the membrane-electrode assembly and the cathode-side separator, such that the oxidant gas can flow through the cathode channel 4c. The anode channel 4a is mainly defined between the membrane-electrode assembly and the anode-side separator, such that the fuel gas can flow through the anode channel 4a. The membrane-electrode assembly includes an electrolyte membrane, and catalyst layers formed on opposite surfaces of the electrolyte membrane.

The oxidant gas supply system 10, which supplies air containing oxygen as oxidant gas to the FC 4, includes a supply pipe 11, discharge pipe 12, bypass pipe 13, air compressor 14, bypass valve 15, intercooler 16, and back pressure valve 17. The supply pipe 11 is connected to an inlet of the cathode channel 4c of the FC 4. The discharge pipe 12 is connected to an outlet of the cathode channel 4c of the FC 4. The bypass pipe 13 communicates with the supply pipe 11 and the discharge pipe 12. The bypass valve 15 is provided at a joint of the supply pipe 11 and the bypass pipe 13. The bypass valve 15 switches the state of communication of the supply pipe 11 with the bypass pipe 13. The air compressor 14, bypass valve 15, and intercooler 16 are arranged in this order from the upstream side on the supply pipe 11. The back pressure valve 17 is located upstream of a joint of the discharge pipe 12 and the bypass pipe 13, on the discharge pipe 12. The air compressor 14 supplies air containing oxygen as oxidant gas, to the FC 4, via the supply pipe 11. The oxidant gas supplied to the FC 4 is discharged through the discharge pipe 12. The intercooler 16 cools the oxidant gas supplied to the FC 4. The back pressure valve 17 adjusts the cathode-side back pressure of the FC 4. The air compressor 14, bypass valve 15, and back pressure valve 17 are driven, under control of the ECU 3. The openings of the bypass valve 15 and the back pressure valve 17 are adjusted by the ECU 3, so that the flow rate of the oxidant gas supplied from the air compressor 14 to the FC 4 is adjusted.

The fuel gas supply system 20, which supplies hydrogen gas as the fuel gas to the FC 4, includes a tank 20T, supply pipe 21, circulation pipe 22, discharge pipe 23, tank valve 24, pressure regulating valve 25, small-flow injector (which will be called “SINJ”) 26a, large-flow injector (which will be called “LINJ”) 26b, gas-liquid separator 27, discharge valve 28, and multi-nozzle ejector (which will be called “MEJ”) 29. The tank 20T and an inlet of the anode channel 4a of the FC 4 are connected by the supply pipe 21. Hydrogen gas as the fuel gas is stored in the tank 20T. The tank valve 24, pressure regulating valve 25, SINJ 26a and LINJ 26b, and MEJ 29 are arranged in this order, from the upstream side of the supply pipe 21. The SINJ 26a and LINJ. 26b are respectively provided in partially bifurcated portions of the supply pipe 21. The opening of the pressure regulating valve 25 is adjusted, in a condition where the tank valve 24 is open, and either one of the SINJ 26a and the LINJ 26b is driven, so as to inject the fuel gas. The fuel gas injected from one of the SINJ 26a and the LINJ 26b is supplied to the FC 4 after passing through the MEJ 29. A portion of the supply pipe 21 downstream of the MEJ 29 is one example of the supply passage.

Each of the SINJ 26a and the LINJ 26b includes a valve seat having an injection hole through which the fuel gas is injected, and a valve body that is driven by a solenoid to open and close the injection hole. Each of the SINJ 26a and the LINJ 26b injects the fuel gas by causing the valve body to be spaced apart from the valve seat over a given time at given intervals, so as to open the valve, and then stops injection of the fuel gas by bringing the valve body into abutting contact with the valve seat over a given time, so as to close the valve. In this case, the duty ratio as the ratio of the valve-opening period to the interval is adjusted, so that an amount of the fuel gas injected each time the valve is opened is changed.

The diameter of the injection hole of the LINJ 26b is set to be larger than that of the injection hole of the SINJ 26a. Accordingly, in the equal valve-opening period, the injection flow rate of the fuel gas injected from the LINJ 26b is larger than that of the fuel gas injected from the SINJ 26a. The injection flow rate of the fuel gas is the amount of fuel gas injected from each injector per unit time. While the amount of the fuel gas injected through either of the SINJ 26a and the LINJ 26b each time the valve is opened can be changed by adjusting the duty ratio, as described above, the upper limit and lower limit of the range in which the amount of fuel gas injected through the LINJ 26b can be changed are respectively set to be larger than those of the range in which the amount of fuel gas injected through the SINJ 26a can be changed. In this embodiment, the fuel gas is injected from only one of the SINJ 26a and the LINJ 26b during power generation of the FC4. In principle, when the output required to be generated by the FC 4 is large, the duty ratio is adjusted according to the magnitude of the required output, and the fuel gas is injected at a large flow rate from the LINJ 26b, as will be described in detail. When the output required of the FC4 is small, the duty ratio is adjusted according to the magnitude of the required output, and the fuel gas is injected at a small rate from the SINJ 26a. Thus, the flow rate of the fuel gas supplied to the FC 4 can be controlled over a wider range, and the output power of the FC 4 can be controlled over a wider range, as compared with the case where the flow rate of the fuel gas supplied to the FC 4 is adjusted by means of a single injector. The SINJ 26a is one example of the first injector, and the LINJ 26b is one example of the second injector.

The circulation pipe 22 connects an outlet of the anode channel 4a of the FC 4 with the MEJ 29. The gas-liquid separator 27 is provided in the circulation pipe 22. The circulation pipe 22 serves to return the fuel gas back to the FC 4. When the fuel gas injected from one of the SINJ 26a and the LINJ 26b passes through the MEJ 29, a negative pressure is generated in the MEJ 29, and the fuel gas discharged from the FC4 under the negative pressure is sucked into the MEJ 29 via the gas-liquid separator 27. In this manner, the fuel gas discharged from the FC 4 is supplied to the FC 4 again. On the circulation pipe 22, a hydrogen concentration sensor S1 that detects the hydrogen concentration in the circulation pipe 22, and a pressure sensor S2 that detects the pressure in the circulation pipe 22, are provided between the FC 4 and the gas-liquid separator 27. The MEJ 29 is one example of the ejector mechanism. The circulation pipe 22 is one example of the circulation passage.

The discharge pipe 23 is connected to the gas-liquid separator 27. The discharge valve 28 is provided in the discharge pipe 23. The gas-liquid separator 27 separates water from the fuel gas discharged from the FC 4, and stores the water. When the discharge valve 28 is opened, the water stored in the gas-liquid separator 27 is discharged to the outside of the fuel cell system 1 via the discharge pipe 23. The discharge pipe 23 is one example of the discharge passage. The tank valve 24, pressure regulating valve 25, SINJ 26a, LINJ 26b, and discharge valve 28 are driven; under control of the ECU 3.

The power control system 30 controls discharge of the FC 4 and charge and discharge of the BAT 8. The power control system 30 includes a fuel cell DC/DC converter (which will be called “FDC”) 32, battery DC/DC converter (which will be called “BDC”) 34, motor inverter (which will be called “MINV”) 38, and accessories inverter (which will be called “AINV”) 39. The FDC 32 controls output current of the FC 4, based on a required current value transmitted from the ECU 3, and adjusts direct-current (DC) power from the FC 4, to deliver the power to the MINV 38 and the AINV 39. The BDC 34 adjusts direct-current (DC) power from the BAT 8, to deliver the power to the MINV 38 and the AINV 39. The power generated by the FC 4 can be stored in the BAT 8. The MINV 38 converts input direct-current (DC) power into three-phase alternating-current power, and supplies the AC power to the motor 50. The motor 50 drives the wheels 5, so as to run the vehicle. The power of the FC 4 and the BAT 8 can be supplied to load devices other than the motor 50, via the AINV 39. Here, the load devices include accessories for the FC4, and accessories for the vehicle, in addition to the motor 50. The accessories for the FC 4 include the air compressor 14, bypass valve 15, back pressure valve 17, tank valve 24, pressure regulating valve 25, SINJ 26a, LINJ 26b, and discharge valve 28. The accessories for the vehicle include an air conditioner, lighting devices, hazard lamps, and so forth.

The ECU 3 includes a central processing unit (CPU), read-only memory (ROM), and random access memory (RAM). The accelerator pedal position sensor 6, air compressor 14, bypass valve 15, back pressure valve 17, tank valve 24, pressure regulating valve 25, SINJ 26a, LINJ 26b, discharge valve 28, FDC 32, BDC 34, hydrogen concentration sensor S1, and pressure sensor S2 are electrically connected to the ECU 3. The ECU 3 calculates the output required to be generated by the FC 4, based on a detection value of the accelerator pedal position sensor 6, driving states of the above-indicated accessories for the vehicle and accessories for the FC 4, electric power stored in the BAT 8, and so forth. Also, the ECU 3 calculates a target current value of the FC 4 corresponding to the required output of the FC 4, and controls the FDC 32 while controlling the flow rates of the oxidant gas and fuel gas supplied to the FC 4 from the air compressor 14 and the SINJ 26a or LINJ 26b, so that the output current value of the FC 4 becomes equal to the target current value.

Multi-Nozzle Ejector

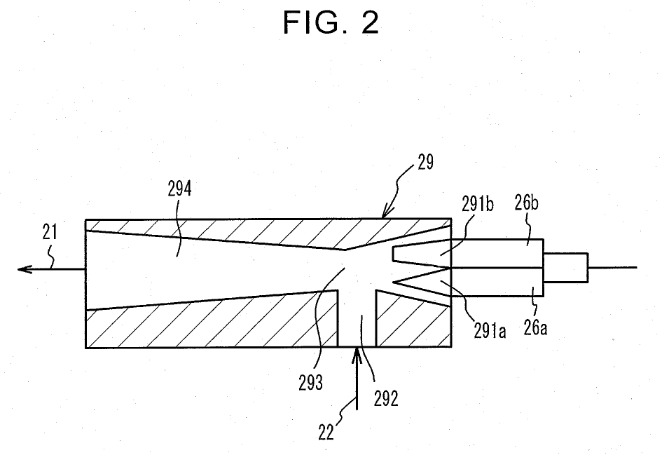

FIG. 2 shows the configuration of the MEJ 29. The MEJ 29 has nozzle portion 291a, nozzle portion 291b, suction portion 292, mixing portion 293, and diffuser portion 294. The nozzle portion 291a and the nozzle portion 291b are connected to the SINJ 26a and LINJ 26b, respectively, and the nozzle portion 291b is formed with the larger diameter than the nozzle portion 291a. The circulation pipe 22 is connected to the suction portion 292. The fuel gas injected from each of the SINJ 26a and the LINJ 26b passes through the MEJ 29 via a corresponding one of the nozzle portion 291a and the nozzle portion 291b, so that the fuel gas discharged from the FC 4 is sucked into the suction portion 292. In the mixing portion 293, the fuel gas injected from one of the SINJ 26a and the LINJ 26b is mixed with the fuel gas discharged from the FC 4. The fuel gas mixed in the mixing portion 293 flows through the diffuser portion 294. The diffuser portion 294 is formed such that its diameter gradually increases toward the downstream side. The fuel newly injected is mixed with the fuel discharged from the FC 4 in the mixing portion 293, and the mixed fuel flows through the diffuser portion 294. During this process, the hydrogen concentration becomes uniform. As a result, the fuel gas having the uniform hydrogen concentration is supplied to the FC 4.

As described above, the fuel gas injected from the LINJ 26b, as well as the fuel gas injected from the SINJ 26a, passes through the MEJ 29. Thus, no matter which of the SINJ 26a and the LINJ 26b injects the fuel gas, the fuel gas discharged from the FC 4 is sucked into the MEJ 29 and re-circulated into the FC 4. Thus, no matter which of the SINJ 26a and the LINJ 26b injects the fuel gas, the fuel gas newly injected can be sufficiently mixed with the fuel gas discharged from the FC 4, and the fuel gas having the uniform hydrogen concentration can be evenly diffused into the FC 4. As a result, the power generation performance of the FC4 is less likely or unlikely to deteriorate. Also, the injection flow rate of the LINJ 26b is large; therefore, when the fuel gas is injected from the LINJ 26b, the rate of increase of the pressure at the inlet side of the anode channel in the FC 4 can be increased, to be higher than that in the case where the fuel gas is injected from the SINJ 26a. Namely, the pressure at the inlet side of the anode channel in the FC 4 can be increased in a short period of time. As a result, discharge of remaining water from the anode channel in the FC 4 is promoted, and the fuel gas can be sufficiently diffused into the anode channel in the FC 4, so that the power generation performance of the FC 4 is improved.

Here, it may be considered to increase the valve-opening period of one of two injectors having the same injection flow rate to be longer than that of the other injector, so as to increase the amount of the fuel gas injected from the one injector each time the valve is open, and thus promote discharge of the remaining water as described above. However, in this case, there is no large difference in the rate of increase of the pressure at the inlet side of the anode channel in the FC 4, no matter which injector injects the fuel gas; therefore, discharge of the remaining water from the anode channel in the FC 4 is less likely or unlikely to be promoted. On the other hand, when the SINJ 26a and LINJ 26b having different injection flow rates are employed as in this embodiment, discharge of remaining water can be promoted by injecting the fuel gas from the LINJ 26b having the larger injection flow rate. The remaining water in the anode channel of the FC 4 is mainly generated when water produced on the cathode side through reaction for power generation of the FC 4 passes through the electrolyte membrane and reaches the anode side.

Since the single MEJ 29 is shared by the two SINJ 26a and LINJ 26b in this embodiment, the number of components is reduced, as compared with the case where ejectors are individually provided for the SINJ 26a and LINJ 26b, and the installation space is also reduced.

Control Mode Switching Control

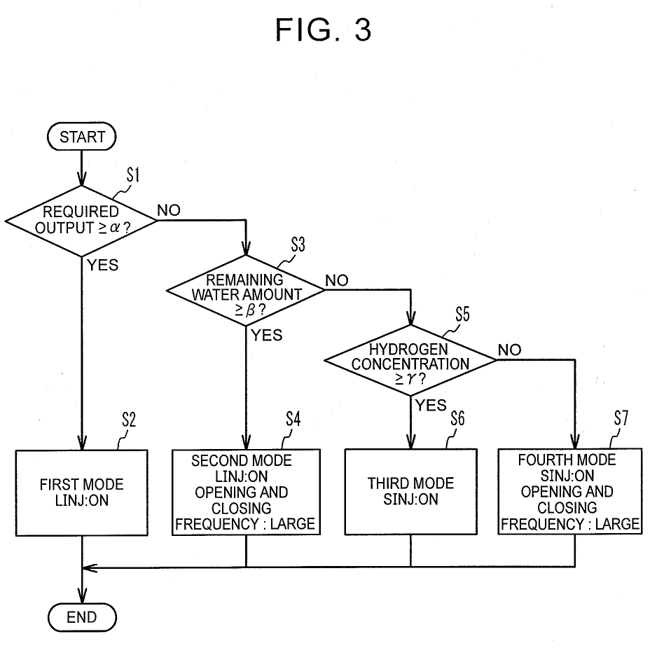

Switching control for switching a control mode for controlling driving of the SINJ 26a, LINJ 26b, and discharge valve 28 is performed, based on the output required to be generated by the FC 4, the amount of water remaining in the anode channel in the FC 4, and the hydrogen concentration in the circulation pipe 22. The switching control is functionally implemented by the CPU, ROM, and RAM of the ECU 3. FIG. 3 is a flowchart illustrating one example of the switching control. The switching control is repeatedly executed.

Required Output

Initially, the ECU 3 determines whether the required output of the FC 4 is equal to or larger than a threshold value α (step S1). As described above, the required output is calculated, based on a detection value of the accelerator pedal position sensor 6, driving states of the accessories for the vehicle and the accessories for the FC 4, electric power stored in the BAT 8, and so forth. The threshold value α is one example of the first threshold value.

First Mode

When an affirmative decision (YES) is obtained in step S1, the ECU 3 switches the control mode to a first mode (step S2). In the first mode, the LINJ 26b, rather than the SINJ 26a, is driven, and the fuel gas is injected at a large flow rate from the LINJ 26b. In this manner, the FC 4 can generate electric power that meets the large required output. Further, since the fuel gas injected from the LINJ 26b passes through the MEJ 29, as described above, the fuel gas injected from the LINJ 26b and the fuel gas discharged from the FC 4 can be sufficiently mixed together, and supplied to the FC 4, so that deterioration of the power generation performance of the FC4 is curbed. Also, when the required output is large, the amount of water produced through reaction for power generation of the FC 4 is also large; however, since the flow rate of the fuel gas injected from the LINJ 26b is large, discharge of the remaining water from the FC 4 is promoted, and the power generation performance of the FC 4 is improved. The ECU 3 opens and closes the discharge valve 28 in predetermined timing, irrespective of the control mode, as will be described later in detail. The discharge valve 28 is opened and closed, such that the discharge valve 28 is opened when the integrated value of output current to the FC 4 from the time when the discharge valve 28 is closed the last time becomes equal to or larger than a predetermined value, and the discharge valve 28 is closed when the amount of reduction of the pressure in the circulation pipe 22 becomes equal to or larger than a predetermined value while the discharge valve 28 is open. With the discharge valve 28 thus opened and closed in the first mode, the remaining water discharged from the FC 4 and stored in the gas-liquid separator 27 is discharged to the outside.

Remaining Water Amount

When a negative decision (NO) is obtained in step S1, the ECU 3 determines whether the amount of water remaining in the anode channel in the FC 4 is equal to or larger than a threshold value β (step S3). The amount of water remaining in the anode channel in the FC 4 will be simply called “remaining water amount” when appropriate. The remaining water amount is constantly estimated, irrespective of whether step S3 is executed. The threshold value β is one example of the second threshold value.

The remaining water amount is estimated based on the impedance of the FC 4, for example. In this case, the remaining water amount is estimated to be large when a resistance component of the impedance is small. The impedance of the FC 4 is calculated based on detection values of a voltage sensor and a current sensor connected to the FC 4. Also, the remaining water amount may be estimated by integrating values obtained with reference to a map that specifies the remaining water amount in advance using the output current of the FC 4 and the temperature of the FC 4. In this case, the temperature of the FC 4 may be estimated based on the temperature of cooling water of the FC 4, for example. Further, the remaining water amount may be estimated, based on a difference in pressure between the inlet and outlet of the anode channel 4a of the FC 4. In this case, when the difference in pressure is large, the remaining water amount is estimated to be large, assuming that a pressure loss of the fuel gas in the FC 4 is large. The difference in pressure may be calculated from a detection value of a pressure sensor provided in the vicinity of the inlet of the anode channel 4a of the FC 4, and a detection value of the pressure sensor S2 provided in the vicinity of the outlet of the anode channel 4a. The method of estimating the remaining water amount is not limited to the methods as described above, but the remaining water amount may be estimated by other methods.

Second Mode

When an affirmative decision (YES) is obtained in step S3, the ECU 3 switches the control mode to a second mode (step S4). In the second mode, the LINJ 26b is driven, and the opening and closing frequency of the discharge valve 28 is increased. When the control mode is switched to the second mode, the required output is small, but the remaining water amount is large; therefore, the fuel gas is injected at a large flow rate from the LINJ 26b, rather than the SINJ 26a, so that discharge of the remaining water from within the FC 4 is promoted. Also, the opening and closing frequency of the discharge valve 28 is increased in the second mode; therefore, the remaining water discharged from the FC 4 and stored in the gas-liquid separator 27 can be discharged to the outside of the system 1. The opening and closing frequency of the discharge valve 28 means the number of times the discharge valve 28 opens and closes in a predetermined period. As described above, the discharge valve 28 opens when the integrated value of the current delivered to the FC 4 from the time when the discharge valve 28 is closed the last time becomes equal to or larger than the predetermined value. The opening and closing frequency of the discharge valve 28 is increased or reduced by changing the predetermined value. For example, when the predetermined value is set to a small value, the opening and closing frequency of the discharge valve 28 is increased relative to the integrated value of the output current of the FC 4. When the predetermined value is set to a large value, the opening and closing frequency of the discharge valve 28 is reduced relative to the integrated value of the output current of the FC 4.

The increase of the opening and closing frequency of the discharge valve 28 in the second mode does not mean that the opening and closing frequency in this mode is higher than that of the discharge valve 28 in the first mode, but means that, in the case where conditions other than the remaining water amount are equal, the opening and closing frequency in the second mode is higher than of a third mode that will be described later. Namely, in the second mode, the predetermined value that specifies the opening and closing frequency of the discharge valve 28 as described above is set to a larger value than the predetermined value in the third mode, so that the opening and closing frequency of the discharge valve 28 is increased. Also, when the control mode is switched to the second mode, the required output is smaller than that in the first mode; therefore, the LINJ 26b is driven at a duty ratio that is smaller than that in the first mode. Namely, in the second mode, the flow rate of the fuel gas injected from the LINJ 26b is reduced to be smaller than that in the first mode.

In the manner as described above, injection of the fuel gas by means of the SINJ 26a and the LINJ 26b can be controlled, based on the required output of the FC 4 or the remaining water amount in the anode channel.

Hydrogen Concentration

When a negative decision (NO) is obtained in step S3, the ECU 3 determines whether the hydrogen concentration of the fuel gas in the circulation pipe 22 is equal to or higher than a threshold value γ (step S5). For example, when power generation is continued in the FC 4 for a given period, impurities, such as nitrogen, contained in air supplied to the cathode side penetrate to the anode side via the electrolyte membrane of the FC 4, and the hydrogen concentration is reduced as the concentration of the impurities of the fuel gas in the circulation pipe 22 increases. As the hydrogen concentration of the fuel gas in the circulation pipe 22 is lower, the hydrogen concentration of the fuel gas circulating through the FC 4 is lower, and the amount of hydrogen available for power generation of the FC 4 is reduced, which may result in deterioration of the power generation performance. The hydrogen concentration in the circulation pipe 22, which is obtained by use of the hydrogen concentration sensor S1, is constantly obtained, irrespective of whether step S5 is executed. The threshold value γ is one example of the third threshold value. The hydrogen concentration is one example of the concentration of the fuel gas.

While the hydrogen concentration in the circulation pipe 22 is obtained based on the hydrogen concentration sensor S1, it may be estimated by other methods. For example, the hydrogen concentration in the circulation pipe 22 may be estimated based on the opening and closing frequency of the discharge valve 28. In this case, as the opening and closing frequency of the discharge valve 28 is higher, a larger amount of impurities can be discharged from within the circulation pipe 22 to the outside, and the hydrogen concentration of the fuel gas in the circulation pipe 22 can be estimated to be a relatively high value. Also, the hydrogen concentration in the circulation pipe 22 may be estimated, based on the pressure in the circulation pipe 22 obtained by the pressure sensor S2. While the amount of the fuel gas supplied to the FC 4 is increased or reduced according to the required output of the FC 4, the fuel gas is consumed in the FC 4 according to the required output. Thus, as the pressure in the circulation pipe 22 is higher, the concentration of the impurities of the fuel gas in the circulation pipe 22 is estimated to be higher, namely, the hydrogen concentration of the fuel gas in the circulation pipe 22 is estimated to be lower. The hydrogen concentration may also be estimated by other methods.

Instead of detecting the hydrogen concentration of the fuel gas in the circulation pipe 22, a hydrogen concentration sensor may be provided between the MEJ 29 of the supply pipe 21 and the FC 4, and hydrogen concentration may be detected by the hydrogen concentration sensor. When the hydrogen concentration sensor is located on the downstream side of the MEJ 29, the sensor is able to detect the hydrogen concentration of the fuel gas circulating through the FC4, even though it is in the supply pipe 21, since the fuel gas newly injected from one of the SINJ 26a and the LINJ 26b and the fuel gas discharged from the FC4 join together in the MEJ 29.

In the manner as described above, the hydrogen concentration of the fuel gas in the circulation pipe 22, or the hydrogen concentration of the fuel gas in the supply pipe 21, is detected, and the hydrogen concentration of the fuel gas circulating through the FC 4 can be estimated from the detected hydrogen concentration of the fuel gas in the circulation pipe 22, or the hydrogen concentration of the fuel gas in the supply pipe 21.

Third Mode

When an affirmative decision (YES) is obtained in step S5, the ECU 3 switches the control mode to a third mode (step S6). In the third mode, the SINJ 26a, rather than the LINJ 26b, is driven. When the control mode is switched to the third mode, a necessary and sufficient amount of fuel gas can be supplied from the SINJ 26a to the FC 4, since the required output is small, and the remaining water amount is also small. Also, since the hydrogen concentration in the circulation pipe 22 is high when the control mode is switched to the third mode, there is no need to increase the opening and closing frequency of the discharge valve 28. As described above, in the third mode, the predetermined value that specifies the opening and closing frequency of the discharge valve 28 is set to a larger value than the predetermined value in the second mode, so that the opening and closing frequency of the discharge valve 28 is reduced in the third mode, as compared with that in the second mode.

Fourth Mode

When a negative decision (NO) is obtained in step S5, the ECU 3 switches the control mode to a fourth mode (step S7). In the fourth mode, the SINJ 26a is driven, and the opening and closing frequency of the discharge valve 28 is increased. When the control mode is switched to the fourth mode, the required output is small and the remaining wall amount is also small, as in the third mode; therefore, a necessary and sufficient amount of fuel gas can be supplied from the SINJ 26a to the FC 4. However, the opening and closing frequency of the discharge valve 28 is increased since the hydrogen concentration in the circulation pipe 22 is low. As a result, discharge of the fuel gas having a low hydrogen concentration and a high concentration of impurities to the outside can be promoted, and the fuel gas having a high hydrogen concentration and a low concentration of impurities is circulated through the FC 4, so that the power generation performance of the FC 4 can be improved. In the fourth mode, too, in the case where conditions other than the hydrogen concentration are equal, the opening and closing frequency of the discharge valve 28 is increased, to be higher than that in the third mode. In the fourth mode, the predetermined value that specifies the opening and closing frequency of the discharge valve 28 is set to a smaller value than the predetermined value in the third mode, so that the opening and closing frequency of the discharge valve 28 is increased in the fourth mode, to be higher than that in the third mode.

In the manner as described above, the opening and closing frequency of the discharge valve 28 can be controlled, based on the required output, and the remaining water amount or the hydrogen concentration of the fuel gas circulating through the FC 4.

In some cases, immediately after an affirmative decision (YES) is obtained in step S3, and the control mode is switched to the second mode, a negative decision (NO) may be obtained in step S3, and the control mode may be switched to the third or fourth mode. Thus, frequent switching of the control mode in a short period, or hunting, may take place. In order to prevent the frequent switching, or hunting, it is preferable that, when the control mode is switched to a given control mode, the given control mode is maintained for a predetermined time, and then the control mode is switched to a different control mode based on the determination results of steps S3 and S5. However, when the control mode is switched from the first mode to a mode other than the first mode, or switched from a mode other than the first mode to the first mode, the control mode may be immediately switched to the one to be established, based on the determination result of step S1, so as to prevent or reduce a delay in response of the output of the FC 4, to a request for acceleration or a request for deceleration.

Timing Chart of Switching Control

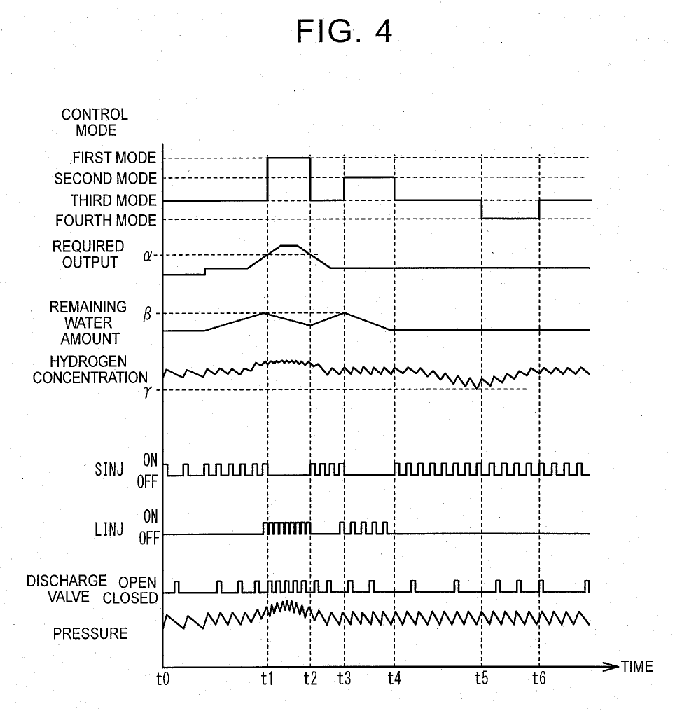

FIG. 4 is a timing chart showing one example of switching control. FIG. 4 shows the control mode implemented, required output of the FC 0.4, remaining water amount on the anode side of the FC 4, hydrogen concentration in the circulation pipe 22 detected by the hydrogen concentration sensor S1, driving states of the SINJ 26a and LINJ 26b, open/closed state of the discharge valve 28, and pressure in the circulation pipe 22 detected by the pressure sensor S2. As described above, the fuel gas is intermittently injected from the SINJ 26a and the LINJ 26b. Thus, the hydrogen concentration and pressure in the circulation pipe 22 rise, in periods in which either of the SINJ 26a and the LINJ 26b is open and the fuel gas is injected from the SINJ 26a or the LINJ 26b, and the hydrogen concentration and pressure in the circulation pipe 22 fall in periods in which the SINJ 26a and the LINJ 26b are closed.

When an operation amount of the accelerator pedal operated by the driver increases, and a request for acceleration is made, in a condition where the third mode is established as shown in FIG. 4 (time t0), the required output of the FC4 increases. When the required output becomes equal to or larger than the threshold value α, the control mode is switched from the third mode to the first mode (time t1), so that the SINJ 26a stops being driven, and the LINJ 26b starts being driven. As a result, the output of the FC4 is increased so as to meet the request for acceleration, and the remaining water amount is reduced. Since the required output of the FC 4 is large in the first mode, the integrated value of the output current of the FC 4 becomes equal to or larger than the predetermined value in a shorter period, as compared with those in the control modes other than the first mode. As a result, the opening and closing frequency of the discharge valve 28 in the first mode increases to be higher than those in the control modes other than the first mode. Thus, while the amount of remaining water stored in the gas-liquid separator 26 increases with increase in the amount of water produced through reaction for power generation of the FC 4 in the first mode, the discharge valve 28 is opened and closed at a sufficiently high frequency, to deal with the amount of remaining water stored in the gas-liquid separator 27.

Then, when the operation amount of the accelerator pedal is reduced, and a request for deceleration is made, the required output is reduced. When the required output becomes smaller than the threshold value α, the control mode is switched from the first mode to the third mode (time t2), so that the LINJ 26b stops being driven, and the SINJ 26a starts being driven. As a result, the output of the FC 4 is reduced, and the remaining water amount in the FC 4 is increased.

The remaining water amount is likely to increase, after the control mode is switched from the first mode to a different control mode other than the second mode. In the second mode, discharge of the remaining water from the FC 4 is promoted since the fuel gas is injected from the LINJ 26b, whereas the fuel gas is injected from the SINJ 26a at a small flow rate, after the control mode is switched from the first mode to a control mode other than the second mode. Thus, a part of the water produced under control in the first mode stays as remaining water in the FC 4, and discharge of water newly produced in the FC 4 is hampered by the remaining water. As a result, the remaining water in the FC 4 gradually increases.

When the remaining water amount becomes larger than the threshold value β, the control mode is switched from the third mode to the second mode (time t3). In the second mode, the SINJ 26a stops being driven, and the LINJ 26b starts being driven. In addition, the opening and closing frequency of the discharge valve 28 is increased, and the remaining water amount is reduced. When the remaining water amount is reduced to be smaller than the threshold value (3 after a lapse of a certain period from switching to the second mode, the control mode is switched from the second mode to the third mode (time t4). If the third mode is continued for a long period, the hydrogen concentration in the circulation pipe 22 is likely to be reduced. Since the opening and closing frequency of the discharge valve 28 is small in the third mode, impurities cannot be discharged from within the circulation pipe 22, and the hydrogen concentration is reduced.

When the hydrogen concentration in the circulation pipe 22 becomes lower than the threshold value γ after a lapse of a certain period from switching to the third mode, the control mode is switched from the third mode to the fourth mode (time t5). Since the opening and closing frequency of the discharge valve 28 is increased in the fourth mode, the hydrogen concentration in the circulation pipe 22 gradually increases. If the hydrogen concentration in the circulation pipe 22 is equal to or higher than the threshold value γ after a lapse of a given period from switching to the fourth mode, the control mode is switched from the fourth mode to the third mode (time t6). Thus, switching between the SINJ 26a and the LINJ 26b, and change of the opening and closing frequency of the discharge valve 28 are performed, according to the remaining water amount in the FC 4 and the hydrogen concentration in the circulation pipe 22, for improvement of the fuel efficiency and improvement of the power generation performance.

Control in Modified Embodiment

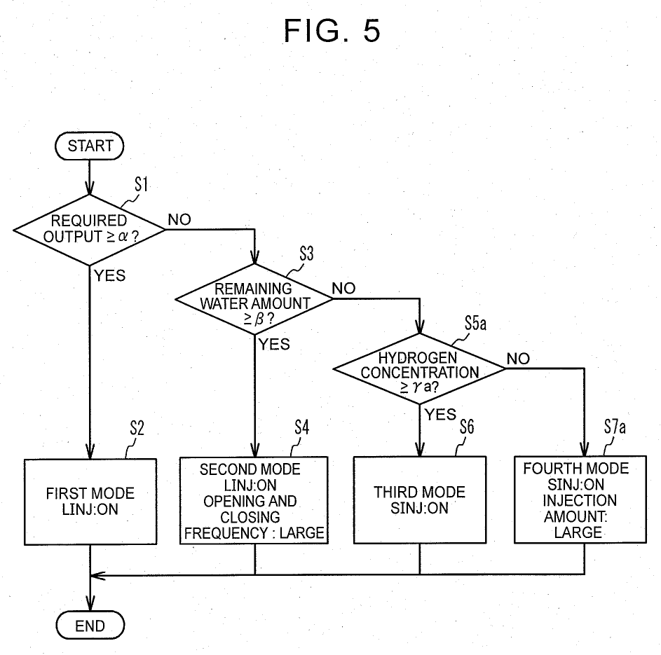

Next, switching control performed by the ECU 3 in a modified embodiment will be described. FIG. 5 is a flowchart illustrating the switching control of the modified embodiment. Here, only the tasks that are different from those of the switching control of the above embodiment will be described using different step numbers. In the modified embodiment, the ECU 3 determines whether the hydrogen concentration is equal to or higher than a threshold value γa (step S5a). When a negative decision (NO) is obtained in step S5a, the control mode is switched to the fourth mode, and the amount of the fuel gas injected from the SINJ 26a is increased (step S7a). The amount of the fuel gas injected is also called injection amount. More specifically, when conditions other than the hydrogen concentration in the circulation pipe 22 are equal, the duty ratio of the SINJ 26a is increased in the fourth mode, to be larger than that in the third mode, and the amount of the fuel gas injected from the SINJ 26a is increased. In this manner, fuel gas having a high hydrogen concentration can be circulated through the FC 4, and the power generation performance of the FC 4 is improved. In the modified embodiment, the opening and closing frequency of the discharge valve 28 in the fourth mode is equal to that in the third mode, but is not limited to this. In the fourth mode, too, the opening and closing frequency of the discharge valve 28 may be increased to be larger than that in the third mode, to an extent that fuel gas having a high hydrogen concentration is not discharged.

In the manner as described above, the amount of the fuel gas injected from the SINJ 26a or the LINJ 26b can be controlled, based on the required output, remaining water amount, or the hydrogen concentration of the fuel gas circulating through the FC 4.

Configuration of Fuel Cell System of Modified Embodiment

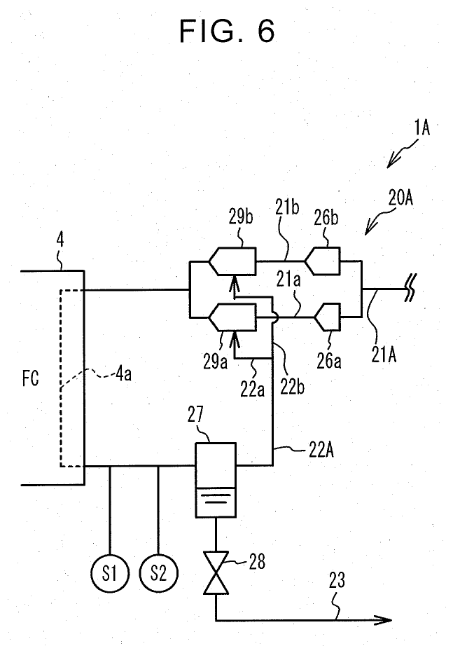

Next, the configuration of a fuel cell system 1A of a modified embodiment will be described. FIG. 6 shows a part of the fuel cell system 1A of the modified embodiment, in particular, a fuel gas supply system 20A of the fuel cell system 1A of the modified embodiment. The same reference numerals are assigned to the same components as those of the above embodiment, and these components will not be repeatedly described. The fuel cell system 1A includes ejectors (which will be called “EJ”) 29a, 29b through which fuel gases injected from the SINJ 26a and the LINJ 26b, respectively, pass. Namely, the fuel gas injected from the SINJ 26a passes only through the ejector 29a, and the fuel gas injected from the LINJ 26b passes only through the ejector 29b. In the fuel cell system 1A, branch pipes 21a, 21b branch off from a supply pipe 21A to form a part of the supply pipe 21A, and the SINJ 26a and the EJ 29a are provided in the branch pipe 21a, while the LINJ 26b and the EJ 29b are provided in the branch pipe 21b. A circulation pipe 22A branches off into branch pipes 22a, 22b, on the downstream side of the gas-liquid separator 27, and the branch pipes 22a, 22b are connected to the EJs 29a, 29b, respectively.

Since the EJs 29a, 29b are dedicated ejectors for the SINJ 26a and the LINJ 26b, respectively, there is no need to take account of the specifications of the LINJ 26b when designing the EJ 29a, and there is no need to take account of the specifications of the SINJ 26a when designing the EJ 29b. Accordingly, each of the EJs 29a, 29b is designed with a sufficiently high degree of freedom. For example, the EJ 29b may be designed in larger size than the EJ 29a, since the flow rate of the fuel gas injected from the LINJ 26b is larger than that of the fuel gas injected from the SINJ 26a.

While the preferred embodiments of the disclosure have been described in detail, the disclosure is not limited to these particular embodiments, but may be embodied with various modifications or changes, within the range of the principle of the disclosure described in the appended claims.

What is claimed is:

1. A fuel cell system comprising:
a fuel cell;
a first injector configured to inject fuel gas;
a second injector configured to inject the fuel gas at an injection flow rate that is larger than that of the first injector;
an ejector mechanism through which the fuel gas injected from each of the first injector and the second injector passes;
a supply passage configured to supply the fuel gas passing through the ejector mechanism to the fuel cell; and
a circulation passage configured to return the fuel gas discharged from the fuel cell to the ejector mechanism.

2. The fuel cell system according to claim 1, further comprising a controller that controls the first injector and the second injector, wherein:
the controller controls the second injector such that the second injector injects the fuel gas when a required output of the fuel cell is equal to or larger than a first threshold value;
the controller controls the second injector such that the second injector injects the fuel gas when the required output is smaller than the first threshold value, and a remaining water amount in an anode channel of the fuel cell is equal to or larger than a second threshold value; and
the controller controls the first injector such that the first injector injects the fuel gas, when the required output is smaller than the first threshold value, and the remaining water amount is smaller than the second threshold value.

3. The fuel cell system according to claim 2, further comprising:
a gas-liquid separator provided in the circulation passage and configured to separate water from the fuel gas;
a discharge passage connected to the gas-liquid separator and configured to discharge the water separated from the fuel gas; and
a discharge valve provided in the discharge passage,
wherein the controller controls the discharge valve to increase an opening and closing frequency of the discharge valve when the remaining water amount is equal to or larger than the second threshold value, as compared with a case where the remaining water amount is smaller than the second threshold value, under the same condition that the required output is smaller than the first threshold value.

4. The fuel cell system according to claim 3, wherein the controller controls the discharge valve to increase the opening and closing frequency of the discharge valve when a concentration of the fuel gas circulating through the fuel cell is lower than a third threshold value, as compared with a case where the concentration of the fuel gas is equal to or higher than the third threshold value, under the same conditions that the required output is smaller than the first threshold value, and the remaining water amount is smaller than the second threshold value.

5. The fuel cell system according to claim 2, wherein the controller controls an amount of the fuel gas injected from the first injector such that the amount of the fuel gas injected from the first injector is increased when a concentration of the fuel gas circulating through the fuel cell is lower than a fourth threshold value, as compared with a case where the concentration is equal to or higher than the fourth threshold value, under the same conditions that the required output is smaller than the first threshold value, and the remaining water amount is smaller than the second threshold value.

6. The fuel cell system according to claim 2, wherein the controller controls an amount of the fuel gas injected from the second injector such that the amount of the fuel gas injected from the second injector is reduced when the required output is smaller than the first threshold value, and the remaining water amount is equal to or larger than the second threshold value, as compared with a case where the required output is equal to or larger than the first threshold value.

7. The fuel cell system according to claim 1, wherein the ejector mechanism comprises a single ejector through which the fuel gas injected from each of the first injector and the second injector passes.

8. The fuel cell system according to claim 1, wherein:
the ejector mechanism comprises a first ejector and a second ejector located downstream of the first injector and the second injector, respectively; and
the circulation passage includes a first branch passage and a second branch passage that branch off from each other and are connected to the first ejector and the second ejector, respectively.

9. The fuel cell system according to claim 1, wherein:
the ejector mechanism is connected to the first injector and the second injector; and
the ejector mechanism is configured to suck the fuel gas that circulates through the fuel cell, when the fuel gas is injected.

10. The fuel cell system according to claim 4, wherein the concentration is estimated from a concentration of the fuel gas of the supply passage or a concentration of the fuel gas of the circulation passage.

11. The fuel cell system according to claim 5, wherein the concentration is estimated from a concentration of the fuel gas of the supply passage or a concentration of the fuel gas of the circulation passage.

12. A control method of a fuel cell system, the fuel cell system including a fuel cell, a first injector configured to inject fuel gas, a second injector configured to inject the fuel gas at an injection flow rate that is larger than that of the first injector, an ejector mechanism through which the fuel gas injected from each of the first injector and the second injector passes, a supply passage configured to supply the fuel gas passing through the ejector mechanism to the fuel cell, and a circulation passage configured to return the fuel gas discharged from the fuel cell to the ejector mechanism, the control method comprising:
detecting a required output of the fuel cell;
estimating a remaining water amount in an anode channel of the fuel cell; and
controlling injection of the fuel gas from the first injector and the second injector, based on the required output and the remaining water amount.

13. The control method according to claim 12, further comprising:
controlling the second injector such that the second injector injects the fuel gas, when the required output of the fuel cell is equal to or larger than a first threshold value;
controlling the second injector such that the second injector injects the fuel gas, when the required output is smaller than the first threshold value, and the remaining water amount in the anode channel of the fuel cell is equal to or larger than a second threshold value; and
controlling the first injector such that the first injector injects the fuel gas, when the required output is smaller than the first threshold value, and the remaining water amount is smaller than the second threshold value.

14. The control method according to claim 13, wherein the fuel cell system further includes a gas-liquid separator provided in the circulation passage and configured to separate water from the fuel gas, a discharge passage connected to the gas-liquid separator and configured to discharge the water separated from the fuel gas, and a discharge valve provided in the discharge passage, the control method further comprising:
detecting a concentration of the fuel gas circulating through the fuel cell; and
controlling an opening and closing frequency of the discharge valve, based on the required output, the remaining water amount, or the concentration.

15. The control method according to claim 14, further comprising
controlling the opening and closing frequency of the discharge valve such that the opening and closing frequency of the discharge valve is increased when the remaining water amount is equal to or larger than the second threshold value, as compared with a case where the remaining water amount is smaller than the second threshold value, under the same condition that the required output is smaller than the first threshold value.

16. The control method according to claim 14, further comprising
controlling the opening and closing frequency of the discharge valve such that the opening and closing frequency of the discharge valve is increased when the concentration is lower than a third threshold value, as compared with a case where the concentration is equal to or higher than the third threshold value, under the same conditions that the required output is smaller than the first threshold value, and the remaining water amount is smaller than the second threshold value.

17. The control method according to claim 13, further comprising:
detecting a concentration of the fuel gas circulating through the fuel cell; and
controlling an amount of the fuel gas injected from the first injector or the second injector, based on the required output, the remaining water amount, or the concentration.

18. The control method according to claim 17, further comprising
controlling the amount of the fuel gas injected from the first injector such that the amount of the fuel gas injected from the first injector is increased when the concentration in either of the supply passage and the circulation passage is lower than a fourth threshold value, as compared with a case where the concentration is equal to or higher than the fourth threshold value, under the same conditions that the required output is smaller than the first threshold value, and the remaining water amount is smaller than the second threshold value.

19. The control method according to claim 17, further comprising
controlling the amount of the fuel gas injected from the second injector such that the fuel gas injected from the second injector is reduced when the required output is smaller than the first threshold value, and the remaining water amount is smaller than the second threshold value, as compared with a case where the required output is equal to or larger than the first threshold value.

20. The control method according to claim 14, wherein the concentration is estimated from a concentration of the fuel gas of the supply passage or a concentration of the fuel gas of the circulation passage.
